(19) United States
(12) Patent Application Publication
(10) Pub. No.: US 2021/0012388 A1
(43) Pub. Date: Jan. 14, 2021

(54) OPERATION SYSTEM FOR MEDIA PLACEMENT AND INCOME DISTRIBUTION

(71) Applicant: HSIANG-CHENG YANG, Kaohsiung City (TW)

(72) Inventor: HSIANG-CHENG YANG, Kaohsiung City (TW)

(21) Appl. No.: 16/506,344

(22) Filed: Jul. 9, 2019

(51) Int. Cl. G06Q 30/02; G06K 9/00; G06Q 20/40

(52) U.S. Cl. CPC G06Q 30/0273; G06Q 20/40; G06K 9/00664; G06Q 30/0246

(57) ABSTRACT

An operation system for media placement and income distribution includes a server and a media broadcast device. The server identifies a media placing end accessing the server and sends an information of rental fee. When the payment is complete, the server integrates the rental fee and calculates and distributes the rental fee to an income account of the server. The server allows the media placing end to transmit a media information through the internet, and the media information is transmitted to the media broadcast device. The media broadcast device is in the physical store for broadcasting the media information. Therefore, the media placing end promotes the media information to the people around the physical store. Also, the server provider and the physical store provider having the income account shares the rental fee. The cooperative benefit of the three parties are assured.

### BACKGROUND OF THE INVENTION

### 1. Field of the Invention

The present invention relates to media operation techniques, and more particularly, to an operation system for media placement and income distribution.

### 2. Description of the Related Art

Due to the advancements of internet technology and the prevailing mobile communication, the internet commercial mode is getting more popular than before. For improving product exposures, most traders places internet advertisements in various network platform for marketing products. Therefore, when users surfs the network platforms through the mobile device, the network platform will broadcast internet advertisements, such that the customers may immediately browse through the products in the advertisements, and the product reputation is accordingly improved.

As a result, the popularity of internet commercial mode has gradually affected the operation mode of the conventional physical stores. For example, a physical store may place the commodities on-sale in the display windows or cabinets, so that the customers passing by the physical store are allowed to browse the commodities on-sale through the display window or cabinet. Therefore, the distribution advertisement objectives are achieved

However, the variety and amount of the commodities displayed in the display window or cabinet are limited, so that the physical store is unable to effectively promote the sales of all the commodities in the store, failing to attract potential customers to enter the store and conduct purchase. Also, some physical stores provides service. Therefore, the display window and glass walls of the store only enable the customers walking by to know the amount of people in the store, failing to be applied for a real-time advertisements marketing objective.

Therefore, an operation related technique for media advertisements achieving a cooperation between the physical store and the network platform providers is needed for the advertisement providers to remotely place the advertisement information at the physical store, so as to assure the efficacy of the cooperation among the network providers, physical store, and advertisement providers and further increase the advertisement exposure.

### SUMMARY OF THE INVENTION

For improving the issues of the display window of the physical store failing to be applied for real-time advertisement marketing, and also improving the disadvantages of internet commercial marketing, an operation system for media placement and income distribution is disclosed. The present invention allows the media placing end to remotely upload media information according to different demands, such that the media information promotes the sale to the crowd that are walking by the physical store, thus improving the media information exposure. Also, the server provider and the physical store equally acquires the rental fee which is paid by the media placing end. Therefore, the benefit of cooperation among the server provide, physical store, and the advertisement provider are assured.

For achieving the aforementioned objectives, an operation system for media placement and income distribution is provided, comprising a server, a user authorization module, a media data transmission module, an income processing module, and a media broadcast device. The user authorization module is disposed in the server for identifying a media placing end accessing the server through the internet and sending a rental fee information to the media placing end, and also identifying if the payment of the rental fee is complete to generate an authorization qualification. The media data transmission module is disposed in the server and coupled with the user authorization module. The media data transmission module includes a data storage unit and an information transmission unit. The data storage unit is applied for confirming the authorization qualification and allowing the media placing end to deliver a media information through the internet, so that the information transmission unit transmits the media information through the internet. The income processing module is disposed in the server and coupled with the user authorization module. The income processing module is applied for establishing an income account and integrating the rental fee, such that the rental fee is calculated and distributed to the income account. The media broadcast device is disposed in a physical store and wirelessly connected with the server. The media broadcast device includes a data processing module, an information receiving module, and a broadcast module that are coupled with each other. The information receiving module wirelessly receives the media information transmitting by the media data transmission module, and the broadcast module broadcasts the media information in the physical store.

With such configuration, the operation system of the present invention allows the media placing end to remotely upload media information, such that the media information is broadcasted toward the crowd near the physical store for commodities marketing, thus improving the media information exposure. Also, the income processing module of the present invention is applied for integrating and calculating the collected rental fee, so as to averagely distribute the rental fee to each income account according to the amount of the income accounts. Therefore, the server provider and the physical store acquires shares the rental fee paid by the media placing end. With the present invention, the cooperative benefit of the server provider, physical store, and media placing end is assured.

### BRIEF DESCRIPTION OF THE DRAWINGS

FIG. 1 is a schematic view illustrating the structure of the system in accordance with an embodiment of the present invention.

FIG. 2 is a block view illustrating the functional structure of the server in accordance with an embodiment of the present invention.

FIG. 3 is a block view illustrating the functional structure of the media broadcast device in accordance with an embodiment of the present invention.

FIG. 4 is a schematic view of the operation status of the system of the present invention, illustrating the individual flow identification module detecting the amount of individuals at the physical store.

FIG. 5 is a flow chart of the operation of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

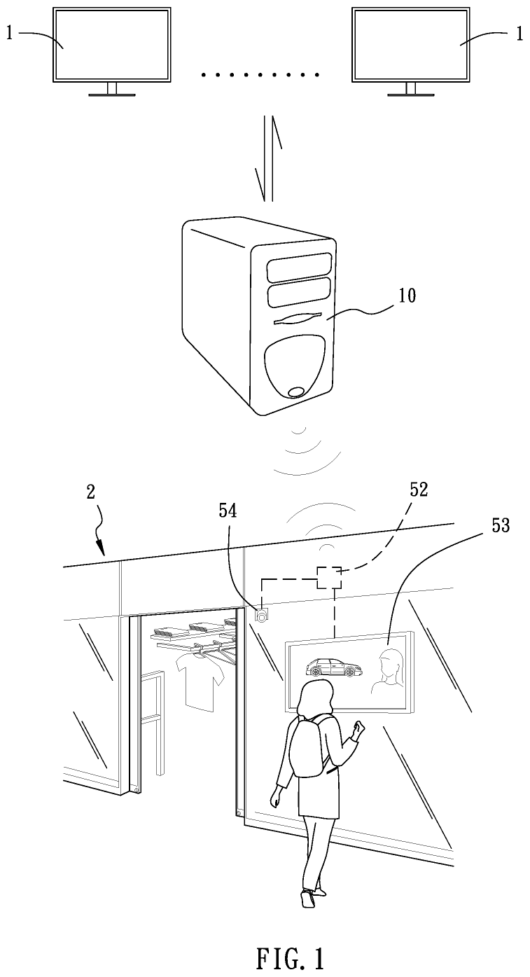

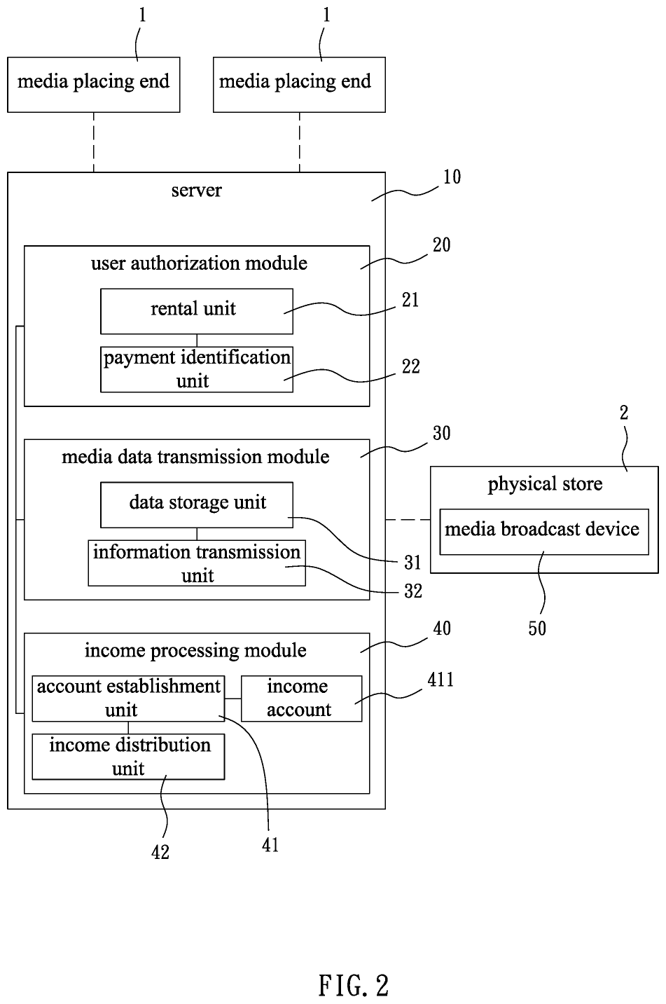

Referring to FIG. 1 to FIG. 5, an operation system for media placement and income distribution in accordance with an embodiment of the present invention comprises a server 10, a user authorization module 20, a media data transmission module 30, an income processing module 40, and a media broadcast device 50. The server 10 is a network server providing access for a media placing end 1 to connect and operate through the internet. In an embodiment of the present invention, the media placing end 1 is allowed to be an advertisement provider or a network store which is able to access the server 10 through a computer device or a smart phone. The user authorization module 20, the media data transmission module 30, and the income processing module 40 are disposed in the server 10. The user authorization module 20 is coupled with the media data transmission module 30 and the income processing module 40. The media broadcast device 50 is disposed on the periphery or a display window of a physical store 2, and wirelessly coupled with the media data transmission module 30 of the server 10.

The user authorization module 20 has a rental unit 21 and a payment identification unit 22. When the media placing end 1 accesses to the server 10, the rental unit 21 sends a rental requirement to the media placing end 1. Also, the rental requirement includes a calculated rental fee. The rental requirement provides various rental options to the media placing end 1, such as a monthly rental plan or a prepaid rental plan. Also, the calculation method of the rental fee is decided according to the chosen rental plan. The payment identification unit 22 is applied for identifying if the media placing end 1 has paid the rental fee. When the payment identification unit 22 identifies that the payment of the rental fee is accomplished, the payment identification unit 22 verifies the media placing end 1 and generates an authorization qualification.

The media data transmission module 30 includes a data storage unit 31 and an information transmission unit 32. The data storage unit 31 confirms the authorization qualification of the media placing end 1, and the media placing end 1 is allowed to transfer a media information to the data storage unit 31. The data storage unit 31 is able to integrate and arrange the broadcast sequence of each media data, which will be sent to the media broadcast device 50 by the information transmission unit 32 through the internet.

The income processing module 40 includes an account establishment unit 41 and an income distribution unit 42. The account establishment unit 41 includes an income account 411, wherein the income account 411 comprises the server provider account and the physical store account. The server provider account is to be established by the server 10 provider, and the physical provider account is to be established by the physical store 2 provider. The income distribution unit 42 is applied for calculating the distribution of the rental fee. For example, the income distribution unit 42 equally distributes the rental fee to the income accounts 411 after calculated according to the amount of the server provider account and the physical store accounts that are included in the income accounts 411. Therefore, the server 10 provider and the physical store 2 provider will acquire the rental fee paid by the media placing end 1.

The media broadcast device 50 comprises a statistic processing module 51, an information receiving module 52, and a broadcast module 53. The statistic processing module 51 is coupled with the information receiving module 52 and the broadcast module 53. The information receiving module 52 wirelessly receives the media information sent by the information transmission unit 32 of the media data transmission module 30. The broadcast module 53 is a display provided with a touch panel, so as to allow the crowd to watch the media information and provide a touch operation function for selecting other media information. Therefore, the media placing end 1 is allowed to upload media information according to different demand, thereby marketing the sale toward the crowd around the physical store 2, increasing the media information exposure.

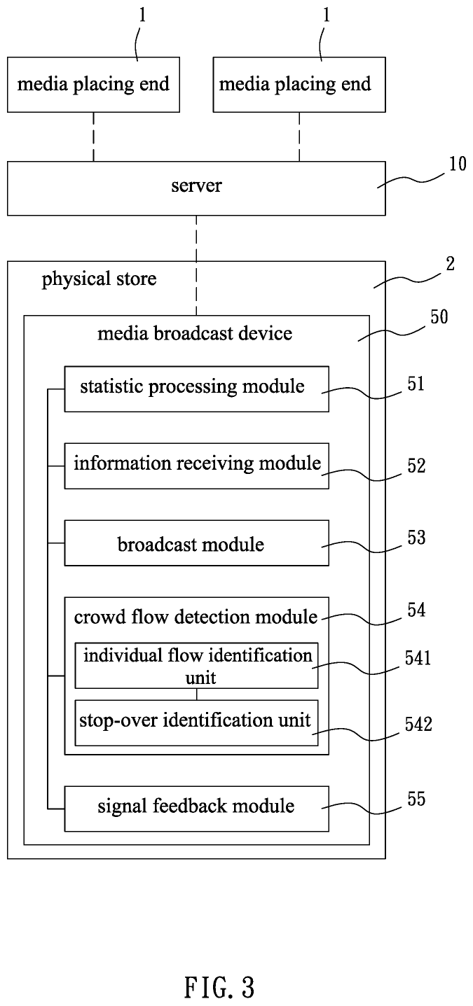

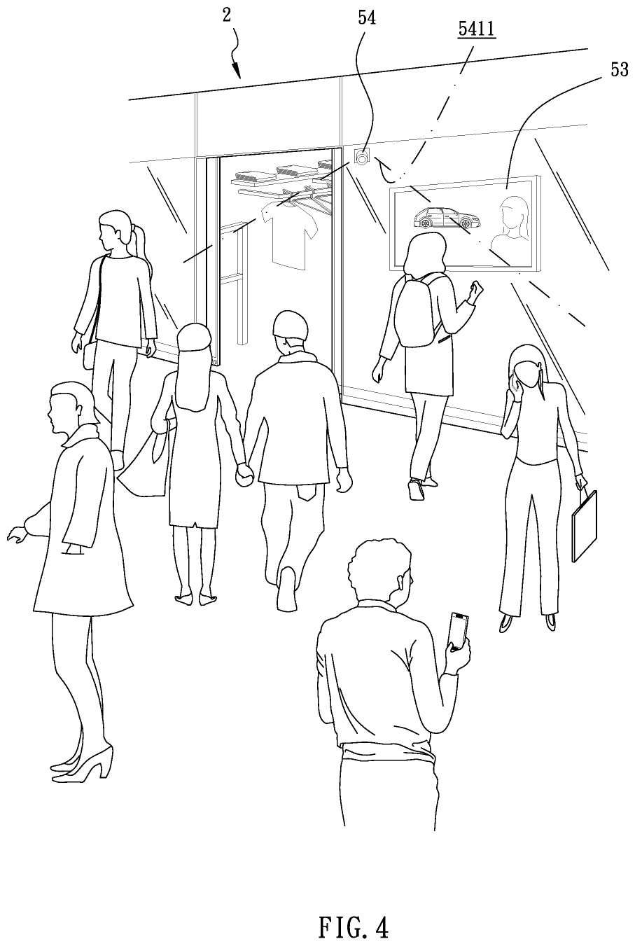

Referring to FIG. 3 and FIG. 4, the media broadcast device 50 further comprises a crowd flow detection module 54 and a signal feedback module 55. The statistic processing module 51 is coupled with the crowd flow detection module 54 and the signal feedback module 55. The crowd flow detection module 54 is applied for detecting the amount of people passing by the physical store 2 to generate a crowd flow information and a stop-over time information. More particularly, the crowd flow detection module 54 has an individual flow identification unit 541 and a stop-over identification unit 542. The individual flow identification unit 541 sets up a detection range 5411 around the physical store 2 for identifying the amount of people passing by the detection range 5411 and accordingly generating the crowd flow signal. In an embodiment of the present invention, the individual flow identification unit 541 identifies the crowd signal through a method selected from a group consisting of light sensing, thermal sensing, image identifying, and a combination thereof. Also, the individual flow identification unit 541 further analyzes the amount of different genders. When people stay in the detection range 5411 to watch the media information broadcasted by the broadcast module 53, the stop-over identification unit 542 is able to immediately record the time duration of the people staying in the detection range 5411 for generating the stop-over time information.

The signal feedback module 55 is applied for receiving the crowd flow signal and the stop-over time information generated by the crowd flow detection module 54. Then, the signal feedback module 55 sends a feedback of the crowd flow signal and the stop-over time information to the server 10, providing a reference of the crowd flow amount and the time spent to watch the media information to the media placing end 1. Therefore, the media placing end 1 is able to immediately analyze the promotion efficacy of the media information.

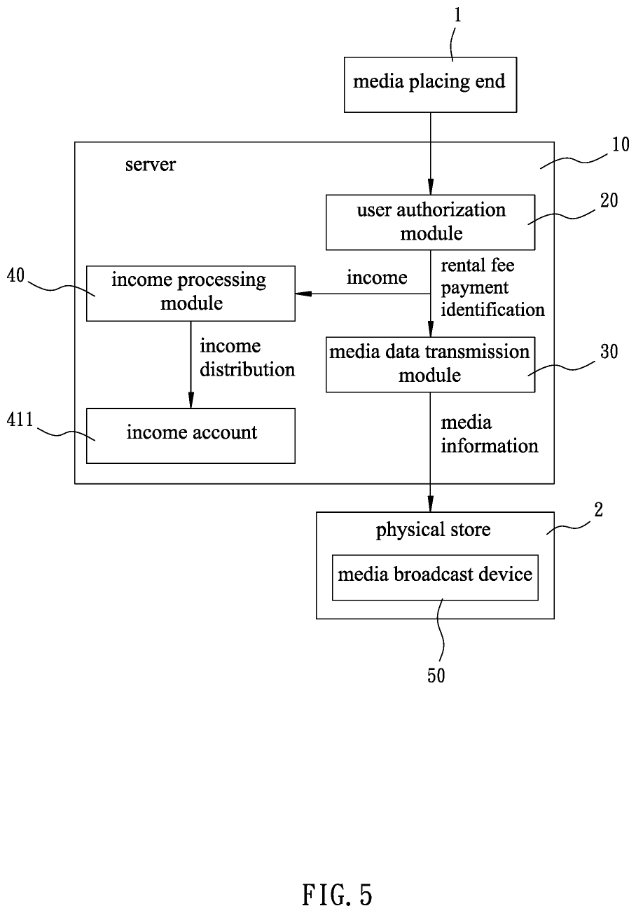

Referring to FIG. 1 and FIG. 5, the server 10 provider is able to recruit the media placing end 1 to apply the server 10. At the meantime, the user authorization module 20 generates the rental fee information for the media placing end 1. When the media placing end 1 accomplishes the payment of the rental fee, the user authorization module 20 generates the authorization qualification for the media placing end 1, so that the media placing end 1 is allowed to upload the media information to the media data transmission module 30, and the media data transmission module 30 transmits the media information to the media broadcast device 50 through the internet, whereby the media broadcast device 50 broadcasts the media information in the physical store 2, thus marketing the sale to the crowd around the physical store 2 and increasing the media information exposure.

Meanwhile, the income processing module 40 is allowed to integrate and calculate the collected rental fee, and averagely distribute the rental fee according to the number of the income accounts 411, such that the server 10 provider and the physical store 2 provider share the rental fee paid by the media placing end 1. Therefore, the cooperative benefit of the server 10 provider, the physical store 2 provider, and the media placing end 1 are assured.

With the foregoing configuration, the present invention achieves following objectives.

The operation system allows the media placing end 1 to remotely upload the media information for marketing the sale to the crowd passing by the physical store 2, so as to increase the media information exposure.

The income processing module 40 is able to integrate and calculate the collected rental fee and averagely distribute the rental fee according to the number of the income accounts 411, such that the server 10 provider and the physical store 2 provider equally shares the rental fee paid by the media placing end 1. Therefore, cooperative benefit of the server 10 provider, the physical store 2 provider, and the media placing end 1 are assured.

The crowd flow detection module 54 immediately detects the people amount around the physical store 2 and generates the crowd flow information and the stop-over time information. Also, the signal feedback module 55 sends a feedback of the crowd flow signal and the stop-over time information back to the server 10, providing a reference of the number of crowd and the time spent to watch the media information to the media placing end 1, thereby allowing the media placing end 1 to immediately analyze the promotion efficacy of the media information.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An operation system for media placement and income distribution, comprising:
a server;
a user authorization module disposed in the server for identifying a media placing end which access the server, and sending a rental fee information indicating a rental fee to the media placing end, such that the user authorization module identifies if the rental fee is paid and generates an authorization qualification;
a media data transmission module disposed in the server and coupled with the user authorization module, the media data transmission module having a data storage unit and an information transmission unit, the data storage unit confirming the authorization qualification and allowing the media placing end to transmit a media information, the information transmission unit transmitting media information through an internet;
an income processing module disposed in the server and coupled with the user authorization module, the income processing module includes an income account and is applied for integrating the rental fee and distributing the rental fee to the income account; and
a media broadcast device disposed in a physical store and wirelessly coupled with the server, the media broadcast device having a statistic processing module, an information receiving module, and a broadcast module that are coupled with each other, the information receiving module receiving the media information transmitted by the media data transmission module, the broadcast module broadcasting the media information in the physical store.

2. The operation system of claim 1, wherein the user authorization module has a rental unit and a payment identification unit, the rental unit sending a rental requirement to the media placing end, wherein the rental requirement includes an information of the rental fee; the payment identification unit identifies if a payment of the rental fee is complete, and when the payment is complete, the payment identification unit verifies the media placing end and generates the authorization qualification.

3. The operation system of claim 1, wherein the income processing module has an account establishment unit and an income distribution unit; the account establishment unit is applied for establishing the income account, and the income distribution unit is applied for calculation a distribution of the rental fee; when a plurality of income accounts are included, the income distribution unit equally distributes the rental fee to the income distribution accounts.

4. The operation system of claim 1, wherein the media broadcast device further comprises a crowd flow detection module coupled with the statistic processing module, the crowd flow detection module being applied for detecting an amount of people around the physical store, so as to generate a crow flow information and a stop-over time information.

5. The operation system of claim 4, wherein the crowd flow detection module has an individual flow identification unit and a stop-over identification unit; the individual flow identification unit sets up a detection range for identifying an amount of people staying in the detection range for generating a crowd flow signal, and the stop-over identification unit is applied for recording a time duration of the crowd staying in the detection range for generating the stop-over time information.

6. The operation system of claim 5, wherein the media broadcast device further comprises a signal feedback module coupled with the statistic processing module, the signal feedback module being applied for receiving the crowd flow signal and the stop-over time information and sending the crowd flow signal and the stop-over time information back to the server.

7. The operation system of claim 5, wherein the individual flow identification unit identifies the crowd flow signal in the detection range through a method selected from a group consisting of light sensing, thermal sensing, image identifying, and a combination thereof.

8. The operation system of claim 1, wherein the broadcast module is a displayer with a touch panel function.
